(19) United States
(12) Patent Application Publication
(10) Pub. No.: US 2025/0348924 A1
(43) Pub. Date: Nov. 13, 2025

(54) Personalized Module Arrangement via Machine Learning

(71) Applicant: eBay Inc., San Jose, CA (US)

(72) Inventors: Yotam Eshel, Ein Iron (IL); Alexander Nus, Herelizya (IL); Haggai Roitman, Yokneam Ilit (IL)

(73) Assignee: eBay Inc., San Jose, CA (US)

(21) Appl. No.: 18/984,451

(22) Filed: Dec. 17, 2024

Related U.S. Application Data
(60) Provisional application No. 63/645,880, filed on May 11, 2024.

(51) Int. Cl. G06Q 30/0601; H04L 67/50

(52) U.S. Cl. CPC G06Q 30/0643; H04L 67/535

(57) ABSTRACT

In implementation of techniques for personalized module arrangement via machine learning, a system receives user interface modules and interaction data corresponding to one or more interaction sessions. Based on the interaction data and the user interface modules, the system generates one or more user history representations via a machine learning model. The system generates, based on the one or more user history representations, interaction likelihood predictions via the machine learning model, wherein each interaction likelihood prediction corresponds to a likelihood of interaction with at least one of the user interface modules. Based on one or more interaction likelihood predictions above a predefined threshold value, the system generates an arrangement of the user interface modules. The system broadcasts the arrangement of the user interface modules for display.

### BACKGROUND

Conventional techniques for arranging modules on a user interface often result in a fixed arrangement for all users, leading to a suboptimal user experience. The fixed nature of the conventional techniques fails to account for each user's interactions. As a result, the conventional techniques yield a static arrangement that does not adapt to the varying needs of users.

Additionally, the sheer volume of information available via the Internet exacerbates this problem. Users are often overwhelmed by irrelevant modules, which can cause frustration and reduce engagement. This mismatch results in several significant issues, including computational inefficiencies, increased power consumption, and lost conversion opportunities.

### SUMMARY

Techniques and systems for personalized module arrangement via machine learning are described. In some examples, a computing device receives a plurality of user interface modules, and interaction data corresponding to one or more interaction sessions. Based on the interaction data and the plurality of user interface modules, the computing device generates one or more user history representations via a machine learning model. The computing device generates, based on the one or more user history representations, a plurality of interaction likelihood predictions via the machine learning model, wherein each of the plurality of interaction likelihood predictions corresponds to a likelihood of interaction with at least one of the plurality of user interface modules.

Based on one or more interaction likelihood predictions of the plurality of interaction likelihood predictions above a predefined threshold value, the computing device generates an arrangement of the one or more user interface modules of the plurality of user interface modules for display. The computing device broadcasts the arrangement of the one or more user interface modules of the plurality of user interface modules for display.

In some examples, the computing device trains the machine learning model by using auxiliary training. In some embodiments, the auxiliary training includes generating a combined loss based on the interaction data and the plurality of user interface modules including the plurality of items by using a plurality of loss functions.

Unlike the conventional techniques, which result in static module arrangements, these dynamic techniques adapt to the varying needs of users and result in improved computational efficiency and decreased power consumption. This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

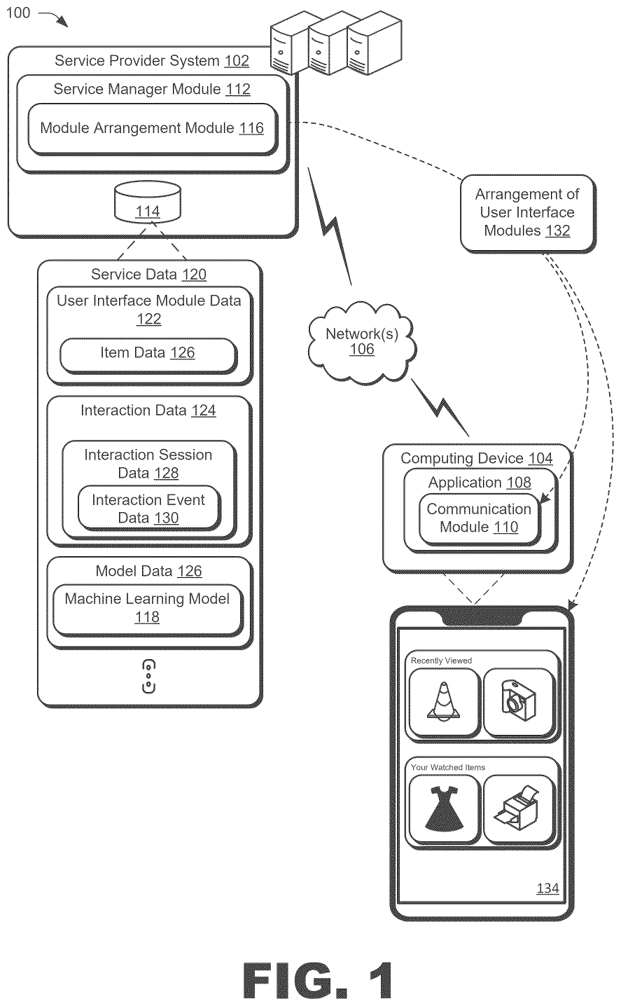

FIG. 1 is an illustration of a digital medium environment in an example implementation that is operable to employ techniques and systems for personalized module arrangement via machine learning, as described herein.

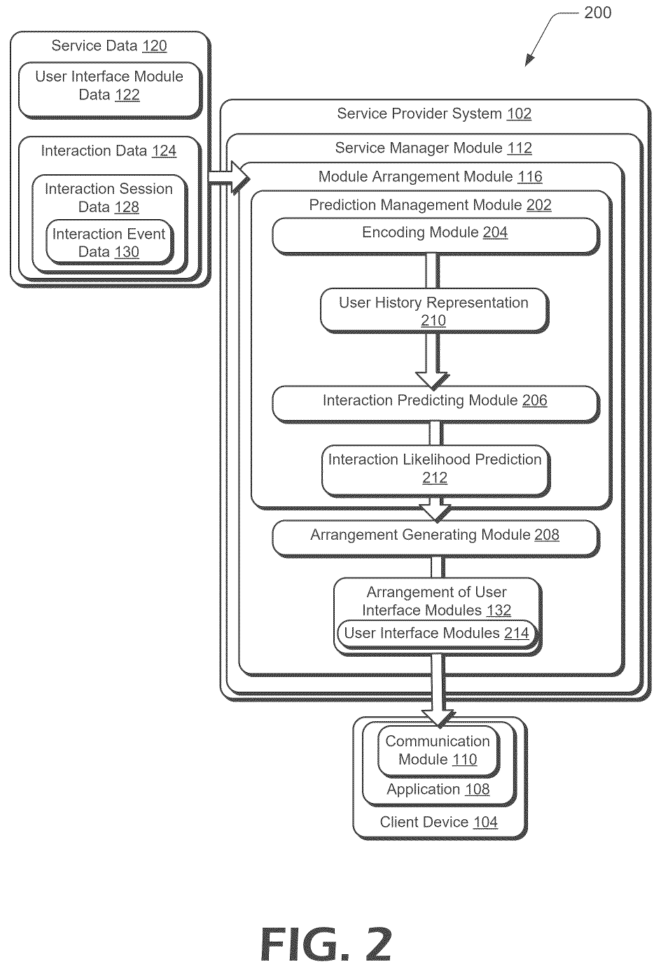

FIG. 2 depicts a system in an example implementation showing operation of the module arrangement module 116 for personalized module arrangement via machine learning.

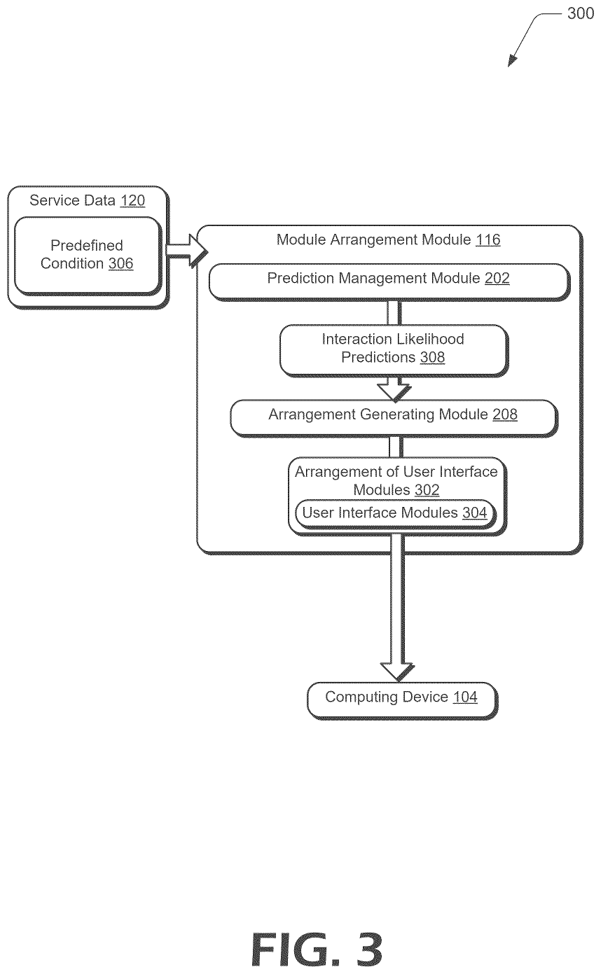

FIG. 3 depicts a system in an example implementation showing operation of the module arrangement module 116 for personalized module arrangement via machine learning responsive to detecting a predefined condition.

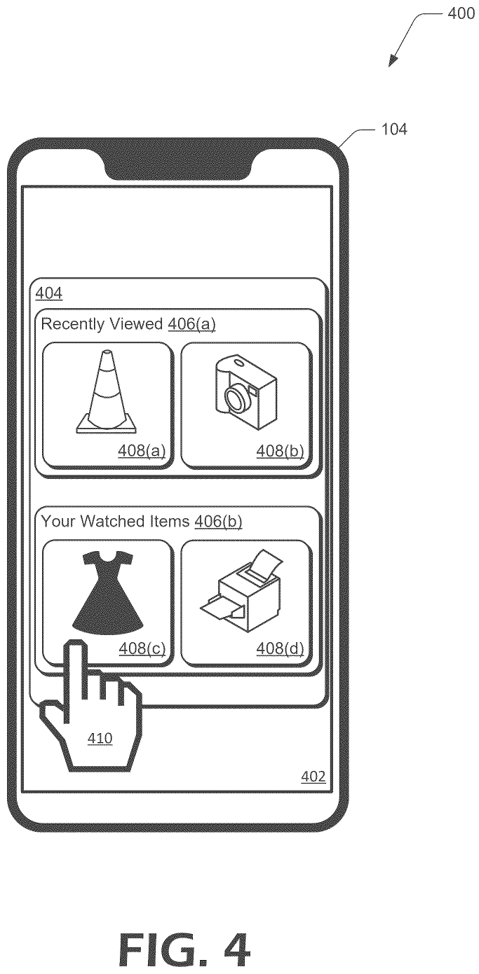

FIG. 4 depicts an example of displaying a static arrangement of user interface modules.

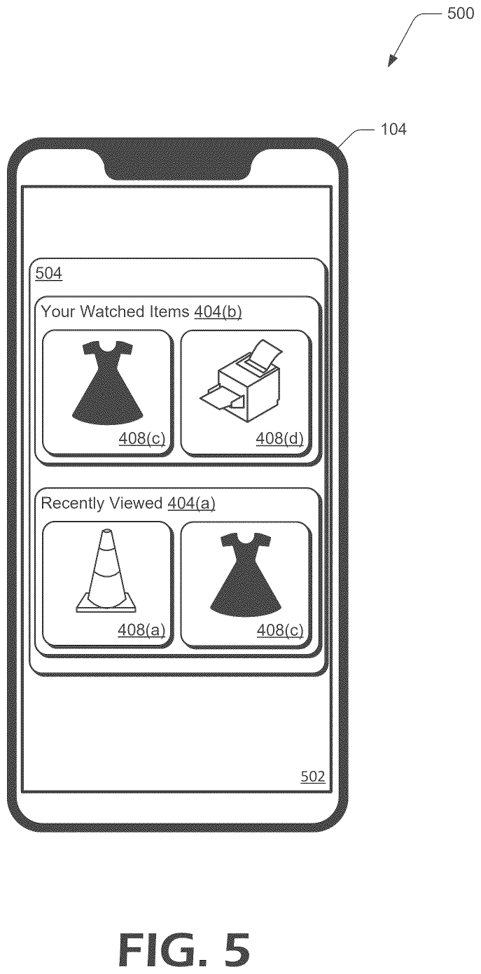

FIG. 5 depicts an example of displaying a personalized arrangement of user interface modules generated via machine learning.

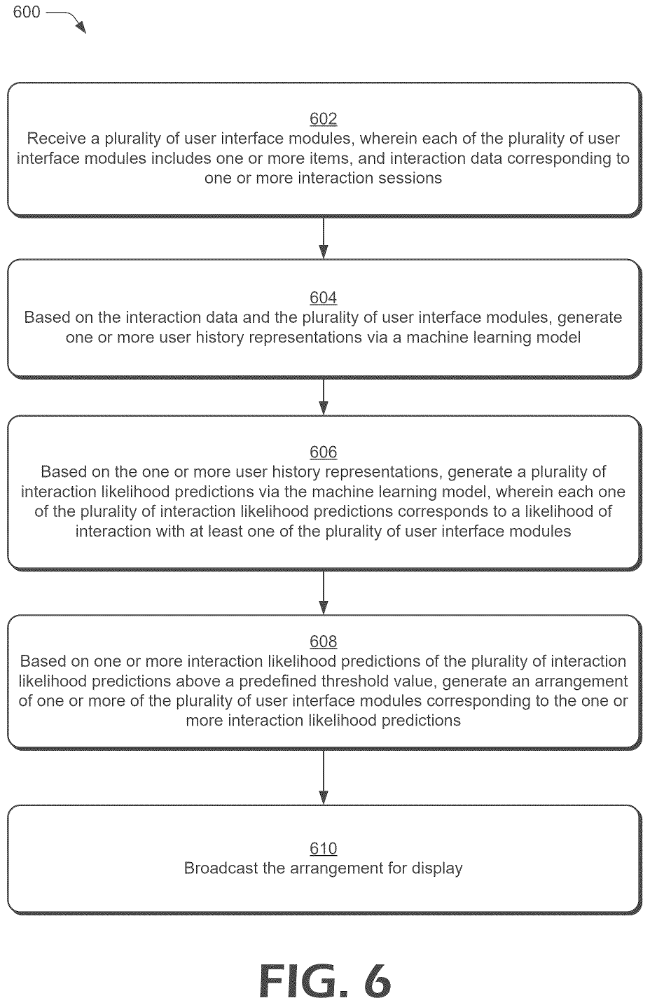

FIG. 6 depicts a procedure in an example implementation of personalized module arrangement via machine learning.

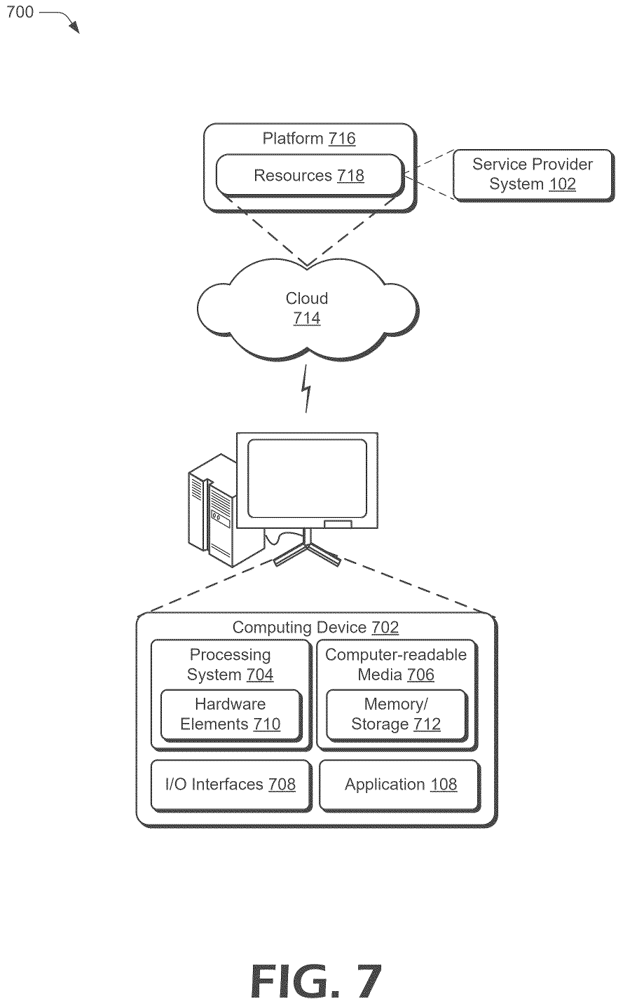

FIG. 7 illustrates an example system including various components of an example device that can be implemented as any type of computing device as FIG. 1 described and/or utilized with reference to FIGS. 1-6 to implement embodiments of the techniques described herein.

### DETAILED DESCRIPTION

### Overview

The mismatch resulting from the conventional techniques for arranging modules on a user interface results in several significant issues, including computational inefficiencies, increased power consumption, and lost conversion opportunities. However, to overcome these problems, techniques for personalized module arrangement via machine learning are described.

For instance, consider an example in which Alice, a user of a service provider system, begins a first interaction session with an application of a service provider system. While browsing the application, Alice views a first module titled “Recently Viewed Items”, which includes various item listings Alice has recently viewed, and a second module titled “Your Watched Items”, which includes various item listings based on her prior interactions. Within the “Your Watched Items” module, Alice interacts with an item listing representing a dress listed via the service provider system. Alice's interactions include three distinct interaction events: (1) viewing the first module titled “Recently Viewed Items”, (2) viewing the second module titled “Your Watched Items”, and (3) selecting the item listing for the dress from the second module titled “Your Watched Items”.

The service provider system records Alice's interaction data from this first interaction session, including interaction session data and interaction event data corresponding to her viewing and selecting interaction activities. The service provider system processes this interaction data by leveraging a machine learning model. By using the machine learning model, the service provider system generates one or more user history representations representing patterns in Alice's behavior, such as her interest in modules showcasing her items of interest.

The service provider system applies the machine learning model to these one or more user history representations and various modules of the service provider system (e.g., the “Recently Viewed” module, a “Trending Now” module, a “Your Orders” module, and so forth) to generate interaction likelihood predictions for the various modules, in which each interaction likelihood prediction corresponds to a likelihood that Alice will interact with a respective module of the various modules.

Based on these interaction likelihood predictions, the service provider system identifies modules with interaction likelihood predictions above a threshold value (e.g., a predetermined threshold value) and generates an arrangement of modules for display based on the interaction likelihood predictions above the threshold value. The arrangement of the modules of the service provider system prioritizes modules that Alice is predicted as being more likely to interact with, based on her previous interactions, such as the “Your Watched Items” module.

The next day, Alice initiates a second interaction session by accessing the application. The service provider system broadcasts the generated arrangement of user interface modules for display to Alice's computing device, in which the “Your Watched Items” module is presented prominently at the top of the user interface, followed by the “Recently Viewed” module. This customized arrangement reflects the service provider system's analysis of Alice's interaction data and the predicted likelihood that she will engage with specific modules.

This adaptive approach enables the generation of module arrangements with machine learning that is continually improved for recent or real-time conditions, thereby enhancing precision predictions of modules that users are likely to engage with. Unlike the conventional techniques, which result in static module arrangements, this dynamic approach adapts to the varying needs of users. Therefore, the described techniques for generating module arrangements with machine learning resolve the shortcomings of the conventional techniques, which fail to account for recent or real-time changes in service provider system operations.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

FIG. 1 is an illustration of a digital medium environment 100 in an example implementation that is operable to employ techniques and systems for personalized module arrangement via machine learning.

The illustrated environment 100 includes a service provider system 102 and a computing device 104. In one or more implementations, the service provider system 102 and the computing device 104 are communicatively coupled, one to another, via network(s) 106. One example of the network(s) 106 is the Internet, although one or more of the computing device 104 and the service provider system 102 may be communicatively coupled using one or more different connections or different networks in various implementations.

Although the service provider system 102 is depicted in the environment 100 as being separate from the computing device 104, in one or more implementations, an entirety or various portions of the service provider system are implemented at or by the computing device 104. In at least one implementation, for example, at least a portion of the service provider system 102 is implemented by an application 108 of the computing device 104 and/or using various resources of the computing device 104, such as hardware resources, an operating system, firmware, and so forth. Alternatively, or additionally, at least a portion of the service provider system 102 is implemented using a third-party service, such as a web services platform that provides one or more hardware and/or other computing resources to support provision of services by web service providers.

Computing devices 104 that implement the environment 100 are configurable in a variety of ways. The computing device 104, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, the computing device 104 ranges from full resource devices with substantial memory and processor resources to low-resource devices with limited memory and/or processing resources. Additionally, although in instances in the following discussion reference is made to the computing device 104 in the singular, the computing device 104 is also representative of a plurality of different devices, such as multiple servers of a server farm utilized to perform operations “over the cloud” as further described in relation to FIG. 7.

In at least one implementation, the application 108 supports communication of data across the network(s) 106 between the computing device 104 and the service provider system 102. In some examples, a communication module 110 of the application 108 supports such data communication. By supporting such data communication, the application 108 provides a respective user of the computing device 104 (and users of other computing devices) access to digital services. For example, the computing device 104 receives data from the service provider system 102. Based on the received data, the application 108 causes various systems of the computing device 104 to output user interfaces and user interface modules, such as by displaying user interfaces and user interface modules via display devices or making accessible voice-based user interfaces.

Through interaction of a user with the computing device 104, the application 108 receives user input via one or more user interfaces corresponding to the application 108. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. In some examples, the application 108 is a browser, which is operable to navigate to a website of the service provider system 102, display pages of the website, and facilitate user interaction with web pages of the service provider system's 102 website. In some embodiments, the application 108 is a web-based computer application of the service provider system 102, such as a mobile application or a desktop application. The application 108 may be configured in different ways, which enable users to interact with their computing devices and by extension perform actions on the application 108, without departing from the spirit or scope of the techniques described.

In one or more implementations, users register with the service provider system 102 to obtain respective user accounts with the digital services of the service provider system 102. Such registration may include, for instance, providing an email address and establishing a username and password combination. Subsequent to registering with the service provider system 102 computing devices (e.g., the computing device 104) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the digital services of the service provider system 102 may be a guest account that does not require a user to sign in or otherwise authenticate to an already established account.

In some examples, the service provider system 102 is configured to generate, via an online marketplace, listings for items and to expose those listings (e.g., publish them) to one or more computing devices, including the computing device 104. For example, the online marketplace may generate listings for items for sale and expose those listings to computing devices, such that the users of the computing devices can interact with the listings via user interfaces to initiate transactions (e.g., purchases, add to wish lists, share, and so on) in relation to the respective item or items of the listings.

In accordance with the described techniques, the service provider system 102 is configured to generate listings for one or more types of physical goods or property (e.g., clothing and/or clothing accessories, collectibles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 106, and NFTs, to name just a few.

In the illustrated environment 100, the service provider system 102 includes a service manager module 112 and a storage device 114. The service manager module 112 is configured to manage the various digital services provided by the service provider system 102. The service manager module 112 includes a module arrangement module 116, which is configured to perform various operations corresponding to module arrangement processes.

Examples of such module arrangement processes include embedding data, encoding data, training a machine learning model 118, generating the machine learning model 118, storing model data 126, vectorizing service data 120, generating representations of service data 120, and so forth. Other examples of such module arrangement processes include generating interaction likelihood predictions corresponding to a likelihood of interaction for various modules, performing auxiliary training corresponding to module arrangement, and so forth.

Examples of the storage device 114 include, but are not limited to, mass storage and virtual storage. In one or more implementations, for example, the storage device 114 may be virtualized across a plurality of data centers and/or cloud-based storage devices. The service provider system 102 may implement the digital services of the service provider system 102 (e.g., an online marketplace) by using servers that execute stored instructions to deploy various services of the service provider system 102, such that those services perform numerous computations which are effective to provide the functionality described above and below.

The storage device 114 includes service data 120 corresponding to the digital services of the service provider system 102, and includes user interface module data 122, item data 126, interaction data 124, interaction session data 128, interaction event data 130, model data 126, and the machine learning model 118. The user interface module data 122 corresponds to data pertaining to the user interface modules.

The item data 126 corresponds to data pertaining to the items presented via the user interface modules. In some examples, the item data 126 includes data corresponding to an item identifier and an item category. In some embodiments, the interaction type includes one or more of a user interface module selection, user interface module view, an item selection, or an item view. In some embodiments, the item data 126 includes digital content corresponding to an item listing.

In some examples, the interaction data 124 pertains to user interface interactions of a particular user of the service provider system 102, however, in some embodiments, additionally, or alternatively, the interaction data 124 corresponds to other users of the service provider system 102. In some embodiments, the users of the service provider system have accounts with the service provider system.

Examples of the interaction data 124 include but are not limited to session identifiers corresponding to interaction sessions, module identifiers corresponding to user interface modules, interaction types for interaction events (e.g., selecting, viewing, etc.), position information representing an order of interaction events or interaction sessions, module attribute information (e.g., a title, a category, etc.) corresponding to attributes of the user interface modules, item attribute information (e.g., a title, a category, etc.) corresponding to attributes of the items, user identifiers, time information, sequence positions, item data, item titles, item categories, item content, user preferences, time since last interaction, and so forth. Examples of interaction types include selecting a user interface module, selecting an item, saving an item, viewing an item, and viewing a user interface module.

The interaction session data 128 pertains to a sequence of interaction events corresponding to a user of the service provider system. The interaction event data 130 corresponds to one or more interaction events (e.g., a selection or a view of a module or an item) by a user. In some embodiments, each interaction event includes interaction event data 130 corresponding to interaction type, user interface module identifier, interaction session identifier, sequence position, and item data.

The model data 126 corresponds to data pertaining to the machine learning model 118. Examples of model data 126 include training data, data embeddings, data representations, and so forth. In some examples, the machine learning model 118 is a Transformer model. In some embodiments, the machine learning model 118 includes a multi-layer architecture and multi-head self-attention. The machine learning model module 116 is configured to generate an arrangement of user interface modules 132 for display via a user interface 134 of the computing device 104.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure.

Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Personalized Arrangement of Modules via Machine Learning

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks.

FIG. 2 depicts a system 200 in an example implementation showing operation of the service provider system 102 of FIG. 1 in greater detail as generating the arrangement of user interface modules 132 via the machine learning model 118. The service provider system 102 implemented in this example includes a service manager module 112 including a module arrangement module 116 including a prediction management module 202 configured to manage predictions associated with user interactions with user interface modules, and an arrangement generating module 208 configured to generate arrangements of user interface modules.

The prediction management module 202 implemented in this example includes an encoding module 204 configured to generate user history representations 210 and an interaction predicting module 206 configured to generate interaction likelihood predictions 212 (e.g., probabilities) that the user will interact with the respective user interface modules.

To begin in this example, the module arrangement module 116 of the service provider system 102 receives the service data 120, in which the service data 120 includes the user interface module data 122 and the interaction data 124 including the interaction session data 128 including the interaction event data 130. In some examples, the user interface module data 122 includes the item data 126. The module arrangement module 116 communicates the service data 120 to the prediction management module 202.

The prediction management module 202 is configurable in a variety of ways, including receiving the service data 120, receiving user inputs from the client device 104, generating a machine learning model for generating predictions corresponding to user interactions with user interface modules, training a machine learning model for generating predictions corresponding to user interactions with user interface modules, and so forth.

In some examples, the prediction management module 202 is configured to train the machine learning model 118 for generating a plurality of interaction likelihood predictions 212, in which each interaction likelihood prediction 212 corresponds to a likelihood of interaction (e.g., by the user) with at least one of the plurality of user interface modules of the user interface module data 122. In some embodiments, the prediction management module 202 trains the machine learning model 118 by minimizing a combined loss function that integrates one or more components, examples of which include cross-entropy loss for classification accuracy, and triplet loss for enhancing representation learning by aligning embeddings of related items while separating unrelated items.

In some examples, the generation of the combined loss by the prediction management module 202 includes identifying selected items and unselected items of the plurality of items based on the interaction data 124, and generating a loss of the combined loss using a loss function from the plurality of loss functions. In some implementations, the plurality of loss functions includes at least one of categorical cross-entropy loss or triplet margin loss. In some embodiments, the generation of the combined loss is based on a categorical cross-entropy loss and a triplet margin loss. In this way, the prediction management module 202 trains the machine learning model 118 to balance predictive accuracy and embedding quality of improved performance.

In some embodiments, the prediction management module 202 detects a predefined condition corresponding to triggering generation of an arrangement of the plurality of user interface modules. Examples of the predefined condition include time-based conditions, user interaction conditions, data update conditions, contextual conditions, and so forth. Examples of the time-based conditions include scheduled updates of the user interface layout for the application 108, a specific time of day, and so forth.

Examples of the user interaction conditions include activity by the user via the application 108 (e.g., after a predefined inactivity period), a specific user interaction, such as selecting an item, selecting a module, closing or navigating away from a module, or searching for a specific term or category. Examples of the data update conditions include new items being added to the item data 126, completion of an interaction session of the interaction session data 128, completion of an interaction event of the interaction event data 130, an addition of a threshold number of interaction events of the interaction event data 130, and so forth. Examples of contextual conditions include a change in a user's context, such as a geographical location change, a device type change, a user's preferences change, and so forth.

The prediction management module 202 communicates the service data 120 to the encoding module 204. As already described, the encoding module 204 is configured to generate user history representations 210. In some examples, the encoding module 204 generates the user history representations 210 based on the interaction data 124 and the plurality of user interface modules of the user interface module data 122. The encoding module 204 is configurable in a variety of ways, including encoding the interaction data 124, generating embeddings for one or more components of the interaction data 124, processing embeddings corresponding to the interaction data 124 via an encoding network (e.g., a multi-layer perceptron), and so forth. To continue this illustrated example system 200, the encoding module 204 generates one or more user history representations 210, which capture patterns within historical interactions. In some examples, the encoding module 204 generates the one or more user history representations 210 via the machine learning model 118.

In some embodiments, as part of the generating of the one or more user history representations 210 via the machine learning model 118, for each interaction event of the interaction data 124, the encoding module 204 generates an interaction event representation. In some examples, the encoding module 204 generates the interaction event representation by generating embeddings or encodings for each portion of interaction data 123 corresponding to the interaction event. In some implementations, the encoding module 204 passes each interaction session through an embedding layer to convert data of the interaction session into a vector representation. In some examples, the encoding module 204 generates a representation for each interaction session from one or more of the interaction events for the interaction session. For example, by combining the interaction events.

In some examples, the encoding module 204 generates data embeddings for the interaction event data 130. In some embodiments, the encoding module 204 generates a representation of an interaction session or an interaction event by combining the respective data embeddings for the interaction session or the interaction event.

In some examples, the encoding module 204 uses multi-head self attention and multi-layer architecture generate the representations, such as the user history representations 210. In some implementations, the encoding module 204 uses a causal mask via the machine learning model 118 to restrict each interaction event to attend to itself or to interaction events that occurred at prior times.

In some implementations, the encoding module 204 uses a triplet loss function to refine the user history representation 210 generated. Triplet loss is a measure used to learn embeddings by ensuring that an anchor is closer to a positive example than to a negative example in the embedding space. In some examples, the encoding module 204 trains the machine learning model to identify a ‘positive item’ (e.g., an item selected in the past, an item viewed in the past, etc.) as closer to the user history representation 210 than a ‘negative item’ (e.g., a item that is not selected in the past), thus enhancing the distinction that the machine learning model 118 makes between items that user is likely to interact with and not likely to interact with.

In some embodiments, the generation of the one or more user history representations 210 by the encoding module 204 includes generating one or more user interaction representations corresponding to the one or more interaction events, and the one or more user history representations 210 are based in part on the one or more user interaction representations.

In some implementations, the generation of the one or more user interaction representations by the encoding module 204 includes generating a plurality of interaction event encodings corresponding to interaction event data of the one or more interaction events, and the generation of the one or more user interaction representations is based in part on the plurality of interaction event encodings. In some examples, the one or more user history representations 210 include vector representations. In some embodiments, each interaction event includes interaction event data 130 corresponding to one or more of: interaction type, user interface module identifier, interaction session identifier, sequence position, or item data.

The encoding module 204 communicates the one or more user history representations 210 to the interaction predicting module 206. As already described, the interaction predicting module 206 is configured to generate the interaction likelihood predictions 212 that the user will interact with the respective user interface modules.

The interaction predicting module 206 is configurable in a variety of ways, including receiving the one or more user history representations 210, processing the one or more user history representations 210, and so forth. To continue this illustrated example system 200, the interaction predicting module 206 generates one or more interaction likelihood predictions 212. In some implementations, the interaction predicting module 206 processes the user history representations 210 via a softmax layer as part of the generating of the one or more interaction likelihood predictions 212.

In some examples, the prediction management module 202 trains the machine learning model 118 by performing an auxiliary task for improving arrangement accuracy by aligning embeddings for the user interface modules the user has interacted with, as indicated in the interaction data 124. In some embodiments, the auxiliary task includes a triplet loss function for adjusting embeddings to be closer in vector space.

The interaction predicting module 206 communicates the interaction likelihood predictions 212 to the arrangement generating module 208. As already described, the arrangement generating module 208 is configured to generate arrangements of user interface modules. The arrangement generating module 208 is configurable in a variety of ways, including receiving the interaction likelihood predictions 212 from the interaction predicting module 206, receiving interaction likelihood predictions 212 from the predication management module 202, ranking interaction likelihood predictions 212, processing interaction likelihood predictions 212, and so forth.

To continue this example system 200, the arrangement generating module 208 generates the arrangement of user interface modules 132 including user interface modules 214 based on the interaction likelihood predictions 212. In some examples, the arrangement generating module 208 generates the arrangement of user interface modules 132 based on one or more of the interaction likelihood predictions 212 (e.g., probabilities) that are above a predefined threshold value. Examples of the interaction likelihood predictions 212 include numerical scores, probabilities, rankings, severity levels, normalized scores, and so forth.

The arrangement generating module 208 is configurable to generate the arrangement of the user interface modules 132 via various techniques, such as via threshold-based filtering, weighted sorting and ranking, grouping based on likelihood levels, and so forth. Various threshold-based filtering implementations are applicable, including fixed thresholds, dynamic thresholds, and context-sensitive thresholds. By way of example, for an example fixed threshold implementation, a predefined static, threshold value (e.g., 0.7) will result in the arrangement generating module 208 selecting modules with likelihoods equal to or over 0.7 to be displayed as the arrangement of the user interface modules 132.

In some weighted sorting and ranking implementations, the arrangement generating module 208 generates the arrangement of the user interface modules 132 such that higher-ranked modules are prioritized in the arrangement. By way of example, if Module A's interaction likelihood prediction 212 is 0.9, Module B's interaction likelihood prediction 212 is 0.7, and Module C's interaction likelihood predictions is 0.5, the arrangement generating module 208 generates the arrangement of the user interface modules 132 as Module A, Module B, and then Module C.

In some embodiments, the arrangement of user interface modules 132 includes one or more user interface modules 214. The one or more user interface modules 214, in some examples, are a subset of the total amount of user interface modules made available by the service provider system 102. By way of example, in some implementations, user interface modules below a predefined threshold value are excluded. For instance, if the predefined threshold value is 0.6, modules with the interaction likelihood predictions 212 0.65, 0.7, and 0.8 are included, and modules with the interaction likelihood predictions 212 0.4 and 0.55 are excluded.

The arrangement generating module 208 broadcasts the arrangement of user interface modules 132 for display by the user interface 134 of the client device 104 via the communication module 110 of the application 108. The communication module 110 displays the arrangement of user interface modules 132 via the user interface 134 of the client device 104. In the context of the module arrangement module 116 and the prediction management module 202, consider the following discussion of machine learning techniques suitable for generating the interaction likelihood predictions 212.

Overall, the prediction management module 202 is configurable to employ any suitable type of machine learning techniques to generate the interaction likelihood predictions 212. In some embodiments, the prediction management module 202 employs one or more of the machine learning techniques described in the discussion below, for generating the interaction likelihood predictions 212.

In what follows, let I be the set of all possible recommendable items, in which each item i∈I has a title (e.g., “GENGAR RARE & HOLO POKEMON CARD LOT x8 (NM/M)”) and a category (e.g., “Toys & Hobbies/Collectible Card Games/CG Mixed Card Lots”).

Let M={m₁, m₂, . . . , mₙ} be the set of all n possible recommendation user interface modules on the user interface 134 for ordering. A user account's history prior to their next visit to the user interface 134 at step T+1 is represented by the sequence of user interactions within the website: S=(s₁, s₂, . . . , s_{T}). Each interaction s∈S is associated with a single item i∈I which was either selected by the user within a given user interface module m or whose item the user has viewed. Given user history S, the prediction management module 202 is configured to generate a representation that can be used to predict the user interface module a user would most likely interact with in their next visit to the user interface 134. To obtain the user history's representation, as a preliminary step, in some examples, the prediction management module 202 obtains a representation of each user interaction in S.

For an interaction s∈S that occurs at step j∈[1, 2, . . . , T], the prediction management module 202 is configured to obtain the details of the item i∈I associated with that interaction event, the interaction's type (e.g., user interface module selection, user interface module view, item selection, item view (e.g., an item description page view), etc.), and the interaction session during which that interaction took place. As already discussed, the prediction management module 202 receives this data as the interaction data 124. In some implementations, the prediction management module 202 is configured to capture the relative position of j of the interaction event within the user's history. For selected user interface modules (e.g., selected homepage user interface modules), the prediction management module 202 is configured to capture the identity of the user interface module m∈M that was selected. Overall, the (d-dimensional) interaction's representation is given by \vec{E}ⱼ=\vec{E}ₘ+\vec{E}ᵢ+\vec{A}_{type}+\vec{P}ⱼ+\vec{S}_{L-l}.

For user interface module selections, \vec{E}ₘ∈ [symbol] ^{d} denotes the (learnable) embedding of user interface module m's identity. In some examples, for item views, the computing device fixes \vec{E}ₘ=\vec{0}.

\vec{A}_{type}∈ [symbol] ^{d} denotes the interaction type embedding (with type∈{0: click, 1: view}). \vec{E}ᵢ∈ [symbol] ^{d} denotes the embedding of the user interface module's selected item, while \vec{P}ⱼ∈ [symbol] ^{d} denotes the j-th event's learnable positional embedding. Assuming that there are L unique sessions within the user's history S and that the current interaction took place during the I-th session, \vec{S}_{L-l}∈ [symbol] ^{d} denotes the corresponding session (index) embedding, with more recent sessions assigned to lower indices within the embedding table. This enables the machine learning model 118 of the prediction management module 202 to learn the relationship between user interface modules or items that were selected/viewed during the same interaction session.

The following discussion continues describing techniques for modeling user interaction history (e.g., generating the user history representations 210) that are implementable by the prediction management module 202. In some service provider system's 102 environments (e.g., environment 100, etc.), the number of items i is very large (dozens of millions) and the number of interaction events per user is relatively small, resulting in a highly sparse dataset to train with. Hence, it is unpractical to represent items only by their identities.

Therefore, in some embodiments, the prediction management module 202 represents items by using the contents of the items. In some examples, the prediction management module 202 obtains Eᵢ using the machine learning model 118. In some examples, the machine learning model 118 is a pre-trained machine learning model, such as a BERT machine learning model. In some instances, the prediction management module 202 concatenates item i's title and category together. In some examples, the prediction management module 202 prepends the item's title and category with a [CLS] token and separates the item's title and category with a [SEP] token.

In some implementations, the prediction management module 202 leverages the token types of the machine learning model 118 to enable the machine learning model 118 to be aware of the title and category parts of its inputs. In this way, the prediction management module 202 enables the machine learning model 118 to ‘collaborate’ item representations based on the title and category similarities of each item. In some examples, the prediction management module 202 encodes each item with the machine learning model 118 and obtains its item representation as the machine learning model's representation of the tokens, such as BERT's representation of the [CLS] token: \vec{e}_{[CLS]}. In some embodiments, the generation of the one or more user history representations by the prediction management module 202 involves generating a plurality of item representations corresponding to one or more items interacted with by the user during the interaction events, and the one or more user history representations are based in part on the plurality of item representations.

Due to efficiency considerations, in some examples of the machine learning model 118 (e.g., the BERT machine learning model examples), the machine learning model 118 is kept frozen. To enable the BERT machine learning model example to adjust BERT's \vec{e}_{[CLS]} representation to the task, the prediction management module 202 projects it using an MLP layer: \vec{E}ᵢ=W²GeLU(W¹\vec{e}_{[CLS]}+\vec{b}¹)+\vec{b}², where W¹∈ [symbol] ^{d×2d} and W²∈ [symbol] ^{2d×d} are the learnable weights and \vec{b}¹∈ [symbol] ^{2d} and \vec{b}²∈ [symbol] ^{d} are the learnable biases.

In some implementations, the prediction management module 202 obtains a representation of S that captures the complex patterns within user's interactions. In some examples, the prediction management module 202 is configured to utilize the machine learning model 118 (e.g., a Transformer machine learning model) which enables the prediction management module 202 to learn complex sequential patterns through a multi-head self-attention (“MHSA”) mechanism and a multi-layer architecture.

In what follows, let

$$= ( {\vec{E}}_{1} , {\vec{E}}_{2} , … , {\vec{E}}_{T} )$$

be the sequence of user interaction embeddings of the interaction data 124. For each step j∈[1, 2, . . . , T], the prediction management module 202 is configured to obtain the corresponding representation of the subsequence of user interactions that inclusively occur up to j. In some examples, the prediction management module 202 achieves that by applying a causal mask to the machine learning model 118, which restricts each interaction to attend only to itself or to interactions that occurred at prior steps. Applying the machine learning model 118 over all the history steps of the interaction data 124, the prediction management module 202 obtains the final user history representation (e.g., the user history representation 210):

$$= Transformer .$$

The following discussion describes suitable machine learning techniques for training and inference of the machine learning model 118 by the prediction management module 202. For training, the prediction management module 202 is configured to consider all steps t∈[1, 2, . . . , T] in a given user's history S in which the user has visited the user interface 134 and selected some item of the application 108 m∈M.

In some implementations, the prediction management module 202 is configured to train the machine learning model 118 to predict which user interface module of the user interface module data 122 m∈M is most likely to have one of its recommended items of the item data 126 interacted with (e.g., selected) by the user. To this end, let

$${\vec{E}}_{t - 1}^{o u t} {=}^{def} {E}_{S}^{out} [ t - 1 ]$$

denote the user's interaction history representation (e.g., the user history representation 210) prior to step t, which may include both previous user interface modules' interactions and item interactions of the interaction data 124. In some examples, the prediction management module 202 is configured to cast the prediction task as a multiclass classification task, having |M|=n classes to choose from. Let

denote an n-dimensional vector, with entry

$${y}_{M}^{( t )} [ m ]$$

denotes the likelihood of having user interface module of the user interface modules 214 m∈M as the next interacted-with (e.g., selected) user interface module by the user at step t via the user interface 134.

Using

$${\vec{E}}_{t - 1}^{o u t} ,$$

the prediction management module 202 is configured to predict such likelihoods using a single linear layer as follows:

$${\hat{y}}_{M}^{( t )} = softmax ( {W}^{c} {\vec{E}}_{t - 1}^{out} + {\vec{b}}^{c} )$$

where W^{c}∈ [symbol] ^{d×n} and \vec{b}^{c}∈ [symbol] ⁿ are learnable parameters. In some examples, by using the multiclass classification task abstraction, the prediction management module 202 is configured to train the machine learning model 118 to minimize the Cross-Entropy (CE) loss at step t, as follows:

$${Loss}_{CE}^{( t )} = - {\sum }_{m = 1}^{n} [ m ] \cdot log ( [ m ] ) , where$$

is a one-hot vector, having the value of 1 for the interacted-with (e.g., selected) user interface module and 0 for all the rest.

During inference time (T+1), the prediction management module 202 is configured to initiate ordering or arranging the user interface modules 214 on the user interface 134 according to the predicted interaction likelihood's

$$.$$

The predicted interaction likelihoods (e.g., the interaction likelihood predictions 212) are configured to be expressed in different ways, such as a normalized score, a ranking, a severity, a probability, a percentage, a fraction, semantically, numerically, or so forth. In some examples, the ordering or arranging of the user interface modules is generated by the module arrangement module 116 or the prediction management module 202 based on a predicted interaction likelihood 212 being higher than a threshold amount (e.g., being a probability above a threshold probability amount or a threshold score), regardless of how the interaction likelihood predictions 212 are expressed. In some examples, the threshold amount or score is predefined.

The following discussion describes suitable machine learning techniques for auxiliary training of the machine learning model 118 by the prediction management module 202. In some examples, while at inference time, the prediction management module 202 does not have access to the user interface module's items. However, the prediction management module 202 does have such prior knowledge during training time.

Hence, in some implementations, the prediction management module 202 utilizes the user's historical item selections (within the user interface modules) of the interaction data 124 to better tune the machine learning model 118 towards capturing the relevance of the user interface modules of the user interface module data 122 to the user's future item preferences.

To this end, in some examples, the prediction management module 202 uses an auxiliary training task, where at each step t with an item selection in a given user interface module, the prediction management module 202 is configured to align the selected item's representation with that of the user's history prior to step t

$$( i . e . , {\vec{E}}_{t - 1}^{out} ) .$$

Let it now denote the item selected by the user at step t and let i_{neg} be a ‘negative item’ which is randomly sampled among all other (unselected) items that were recommended within any user interface module m∈M that was displayed to the user at step t.

Using a contrastive learning approach, the prediction management module 202 is configured to train the machine learning model 118 to learn the user history representation 210 prior to the selection event,

$${\vec{E}}_{t - 1}^{out} ,$$

to be as similar as possible to the representation of the selected item iₜ; while at the same time, be as dissimilar as possible to that of the unselected item i_{neg}.

Utilizing such an approach enables the machine learning model 118 to refine its user history representation 210 to reflect more fine-granular future relevance signals. In some examples, the prediction management module 202 achieves this by training the machine learning model 118 to minimize the following Triplet Margin with Distance loss:

$${Loss}_{alignment}^{( t )} = max \{ cos ( {\vec{E}}_{t - 1}^{out} , {\vec{E}}_{{i}_{p}} ) - cos ( {\vec{E}}_{t - 1}^{out} , {\vec{E}}_{{i}_{neg}} ) + ϵ , 0 \} ,$$

where cos() denotes the cosine-similarity and E is the distance margin hyperparameter. In some embodiments, both training tasks are combined as follows with λ∈[0,1] as a hyperparameter:

$${Loss}^{( t )} = {Loss}_{CE}^{( t )} + λ \cdot {Loss}_{alignment}^{( t )} .$$

In the context of the service provider system 102, consider the following discussion of FIG. 3. FIG. 3 depicts a system 300 in an example implementation showing operation of the module arrangement module 116 of FIGS. 1 and 2, in which the module arrangement module 116 generates an arrangement of user interface modules 302 including user interface modules 304 via the machine learning model 118, based on a predefined condition 306.

As already noted, the illustrated system 300 includes the module arrangement module arrangement module 116, which includes the prediction management module 202 and the arrangement generating module 208 of FIG. 2.

To begin this example of the system 300, the module arrangement module 116 receives the service data 120 including a predefined condition 306. In some examples, the predefined condition 306 includes interaction data 124 that is updated, such as updated interaction data that is recent or real-time. Additionally, or alternatively, the module arrangement module 116 detects the predefined condition 306. In some implementations, the predefined condition 306 is an access request for the application 108.

Examples of the predefined condition 306 include time-based conditions, user interaction conditions, data update conditions, contextual conditions, and so forth. Examples of the time-based conditions include scheduled updates of the user interface layout for the application 108, a specific time of day, and so forth.

Examples of the user interaction conditions include activity by the user via the application 108 (e.g., after a predefined inactivity period), a specific user interaction, such as selecting an item, selecting a module, closing or navigating away from a module, searching for a specific term or category, etc., and so forth. Examples of the data update conditions include new items being added to the item data 126, completion of an interaction session of the interaction session data 128, completion of an interaction event of the interaction event data 130, an addition of a threshold number of interaction events of the interaction event data 130, and so forth. Examples of contextual conditions include a change in a user's context, such as a geographical location change, a device type change, a user's preferences change, and so forth.

Responsive to receiving or detecting the predefined condition 306, the module arrangement module 116 uses the prediction management module 202 and the machine learning model 118 to generate the arrangement of user interface modules 302. In some examples, the prediction management module 202 communicates an interaction likelihood prediction 308 that was previously generated by the prediction management module 202.

In some implementations, the prediction management module 202 generates (e.g., in real-time) the interaction likelihood prediction 308 based on updated service data 120, such as the predefined condition 306 or the interaction data 124. The prediction management module 202 communicates the interaction likelihood predictions 308 to the arrangement generating module 208.

As already discussed, the arrangement generating module 208 is configured to generate the arrangement of user interface modules 302 including the user interface modules 304 based on the interaction likelihood predictions 308. The arrangement generating module 208 generates the arrangement of user interface modules 302 and communicates it to the computing device 104 for broadcasting via the user interface 134. In the context of the computing device 104 and the service provider system 102, consider the following discussion of FIGS. 4 and 5.

FIG. 4 depicts an example 400 of displaying a non-personalized arrangement of user interface modules via a user interface 402 of the computing device 104 during a first interaction session of a user of the service provider system 102. To begin this example 400, Bob, a user of the service provider system 102, begins a first interaction session with the application 108 of the service provider system 102.

A user interface 402 of Bob's computing device 104 displays an impersonalized arrangement of user interface modules 404, including a “Recently Viewed” module 406(a) and a “Your Watched Items” module 406(b). The “Recently Viewed” module 406(a) includes item 408(a), a traffic cone, and item 408(b), a camera. The “Your Watched Items” module 406(b) includes item 408(c), a dress, and item 408(d), a printer.

While browsing the application 108, Bob views the “Recently Viewed” module 406(a) and the “Your Watched Items” module 406(b). Within the “Your Watched Items” module 406(b), Bob interacts with the item 408(c), a dress listed on the service provider system 102, by selecting it via user input 410.

Bob's interaction session data 128 includes three distinct interaction events: (1) viewing the “Recently Viewed” module 406(a), (2) viewing the “Your Watched Items” module 406(b), and (3) selecting the item 408(c).

The service provider system 102 receives Bob's interaction data 124 from the interaction session of example system 300 from the computing device 104's communication module 110, including interaction session data 128 and interaction event data 130 corresponding to Bob's viewing and selecting interaction events.

The service provider system 102 processes this interaction data 124 by leveraging the prediction management module 202 and the machine learning model 118. By using the prediction management module 202 and the machine learning model 118, the service provider system 102 generates one or more user history representations 210 representing patterns in Bob's behavior, such as his interest in modules showcasing his items of interest.

The service provider system 102 applies the machine learning model 118 to these one or more user history representations 210 and the various modules of the service provider system 102 (e.g., “Recently Viewed” module 406(a) and the “Your Watched Items” module 406(b), among others) to generate interaction likelihood predictions 212 for the various modules, in which each interaction likelihood prediction 212 corresponds to a likelihood that Bob will interact with a respective module of the various modules of the user interface module data 122.

Based on these interaction likelihood predictions 212, the service provider system 102 identifies one or more modules with interaction likelihood predictions 212 above a threshold value (e.g., a predetermined threshold value) and generates an arrangement of modules 504 for display via a user interface 502 based on the interaction likelihood predictions 212 above the threshold value. The arrangement of modules 504 of the service provider system 102 prioritizes modules that Bob is predicted as being more likely to interact with, based on his previous interactions during the interaction session of FIG. 4, such as the “Your Watched Items” module 406(b).

In the context of the example 400, consider the following discussion of FIG. 5. FIG. 5 depicts an example 500 of displaying a personalized arrangement of user interface modules via a user interface 402 of the computing device 104 of FIGS. 1 and 4. To begin this example 500, the service provider system 102 detects that Bob initiates a new interaction session by accessing the application 108. In this example 500, the service provider system 102's detection of the new interaction session is detection of a predefined condition 306.

Responsive to the detection of the predefined condition, the service provider system 102 broadcasts the arrangement of modules 504 generated to Bob's user interface 502, in which the “Your Watched Items” module 406(b) is presented prominently at the top of the user interface 502, followed by the “Recently Viewed” module 404(a). In some examples, the service provider system 102 generates an updated version of the arrangement of modules based on recent or real-time service data 120, such as real-time interaction data 124. This personalized arrangement (the arrangement of modules 504) reflects the service provider system's 102 analysis of Bob's interaction data 124 via the machine learning model 118 and the interaction likelihood prediction 212 that Bob will engage with the user interface modules 406(a) and 406(b) of the arrangement of modules 504. In the context of the personalized module arrangement techniques via machine learning, consider the following discussion of FIG. 6.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks.

FIG. 6 depicts a procedure 600 in an example implementation of personalized module arrangement via machine learning.

At block 602, a plurality of user interface modules and interaction data corresponding to one or more interaction sessions is received, wherein each of the plurality of user interface modules includes one or more items. In some examples, the module arrangement module 116 of the service provider system 102 receives the service data 120, which includes user interface module data 122 and interaction data 124, such as interaction session data 128 and interaction event data 130. In some examples, the user interface module data 122 includes the item data 126.

At block 604, based on the interaction data and the plurality of user interface modules, one or more user history representations are generated via a machine learning model. As already discussed throughout, the encoding module 204 is configured to generate user history representations 210. In some implementations, the encoding module 204 generates the user history representations 210 based on the interaction data 124 and the plurality of user interface modules of the user interface module data 122.

In some examples, the encoding module 204 generates component representations for each component of each interaction event of the interaction events, generates interaction event representations for each interaction event by combining the component representations corresponding to each respective interaction event, and generates a user history representation for each interaction session by organizing the corresponding interaction event representations sequentially and aggregating the corresponding interaction event representations organized sequentially.

At block 606, based on the one or more user history representations, a plurality of interaction likelihood predictions is generated via the machine learning model, wherein each one of the plurality of interaction likelihood predictions corresponds to a likelihood of interaction with at least one of the plurality of user interface modules. In some examples, the interaction predicting module 206 generates, based on the one or more user history representations 210, the interaction likelihood predictions 212 that the user will interact with the respective user interface modules. Examples of the interaction likelihood predictions 212 include, but are not limited to numerical scores, probabilities, rankings, severity levels, or normalized scores.

At block 608, based on one or more interaction likelihood predictions of the plurality of interaction likelihood predictions above a predefined threshold value, an arrangement of one or more of the plurality of user interface modules corresponding to the one or more interaction likelihood predictions is generated. The arrangement generating module 208 is configurable to generate, based on the interaction likelihood predictions 212, the arrangement of the user interface modules 132 via various techniques, such as via threshold-based filtering, weighted sorting and ranking, grouping based on likelihood levels, and so forth. In some examples, the arrangement generating module 208 generates the arrangement of user interface modules 132 based on one or more of the interaction likelihood predictions 212 (e.g., probabilities) that are above a predefined threshold value.

At block 610, the arrangement is broadcasted for display. In some examples, the arrangement generating module 208 broadcasts the arrangement of user interface modules 132 for display by the client device 104 via the communication module 110 of the application 108.

Having described examples of procedures in accordance with one or more implementations, consider now an example of a system and device that can be utilized to implement the various techniques described herein.

### Example System and Device

FIG. 7 illustrates an example system generally at 700 that includes an example computing device 702 that is representative of one or more computing systems and/or devices that implement the various techniques described herein. This is illustrated through inclusion of the service provider system 102 and the application 108. The computing device 702 is configurable, for example, as a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (for example, one or more computing devices and/or processing systems 704) to implement techniques, modules, and examples described herein.

The techniques described herein are supported by various configurations of the computing device 702 and are not limited to the specific examples of the techniques described herein. This functionality is also implementable through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

What is claimed is:

1. A method comprising:
receiving, by a computing device, a plurality of user interface modules, wherein each one of the plurality of user interface modules includes one or more items, and interaction data corresponding to one or more interaction sessions;
based on the plurality of user interface modules and the interaction data, training, by the computing device, a machine learning model for generating a plurality of interaction likelihood predictions, wherein each one of the plurality of interaction likelihood predictions corresponds to a likelihood of interaction by a user with at least one of the plurality of user interface modules;
detecting, by the computing device, a predefined condition corresponding to triggering generation of an arrangement of the plurality of user interface modules;
responsive to the detecting, generating, by the computing device, the arrangement of the plurality of user interface modules, wherein the generating comprises:
based on the interaction data, generating, by the computing device, one or more user history representations via the machine learning model;
based on the user history representations, generating, by the computing device, the plurality of interaction likelihood predictions via the machine learning model; and
based on one or more of the plurality of interaction likelihood predictions above a threshold value, generating, by the computing device, an arrangement of the one or more of the plurality of user interface modules; and
broadcasting, by the computing device, the arrangement of the one or more of the plurality of user interface modules for display.

2. The method of claim 1, wherein the training of the machine learning model further comprises:
identifying, by the computing device, selected items and unselected items of the one or more items by using the interaction data;
based on the selected items and the unselected items identified, generating, by the computing device, a combined loss by using a plurality of loss functions; and
updating, by the computing device, the machine learning model by using the combined loss generated.

3. The method of claim 1, wherein the training of the machine learning model further comprises:
based on the interaction data and the plurality of user interface modules, generating, by the computing device, a combined loss by using a plurality of loss functions; and
updating, by the computing device, the machine learning model via the combined loss generated.

4. The method of claim 3, wherein the generating of the combined loss further comprises:
based on the interaction data and the plurality of modules, identifying, by the computing device, selected items and unselected items of the one or more items; and
generating, by the computing device, a loss of the combined loss via a loss function of the plurality of loss functions by using the selected items and unselected items.

5. The method of claim 3, wherein the plurality of loss functions includes at least one of categorical cross-entropy loss or triplet margin loss.

6. The method of claim 1, further comprising receiving, by the computing device, a request from a client device to access the user interface, and wherein the generating of the arrangement of the one or more user interface modules is responsive to the receiving of the request

7. The method of claim 1, wherein each interaction session includes one or more interaction events.

8. The method of claim 7, wherein the generating of the one or more user history representations further comprises based on the interaction data, generating a plurality of item representations corresponding to one or more items interacted with during the interaction events, and wherein the one or more user history representations are generated based in part on the plurality of item representations.

9. The method of claim 7, wherein the generating of the one or more user history representations further comprises based on the interaction data, generating one or more user interaction representations corresponding to the one or more interaction events, and wherein the one or more user history representations are generated based in part on the one or more user interaction representations.

10. The method of claim 9, wherein the generating of the one or more user interaction representations further comprises:
based on the interaction data, generating a plurality of interaction event encodings corresponding to interaction event data of the one or more interaction events, and wherein the generating of the one or more user interaction representations is based at least in part on the plurality of interaction event encodings.

11. A method for user interface modules arrangement, the method comprising:
receiving, by a computing device, a plurality of user interface modules, wherein each one of the plurality of user interface modules includes one or more items, and interaction data corresponding to one or more interaction sessions;
based on the interaction data and the plurality of user interface modules, generating, by the computing device, one or more user history representations via a machine learning model;
based on the one or more user history representations, generating, by the computing device, a plurality of probabilities via the machine learning model, wherein each one of the plurality of probabilities corresponds to a likelihood of interaction with at least one of the plurality of user interface modules;
based on one or more of the plurality of probabilities above a threshold value, generating, by the computing device, the arrangement of the one or more of the plurality of user interface modules; and
broadcasting, by the computing device, the arrangement of the one or more of the plurality of user interface modules for display.

12. The method of claim 11, wherein the one or more user history representations include vector representations.

13. The method of claim 11, further comprising aligning, by the computing device, embeddings of the one or more user history representations via a loss function.

14. The method of claim 11, wherein each of the one or more interaction events includes interaction event data corresponding to one or more of: interaction type, user interface module identifier, interaction session identifier, sequence position, or item data.

15. The method of claim 14, wherein the item data includes data corresponding to an item identifier and an item category.

16. The method of claim 14, wherein the interaction type includes one or more of a user interface module selection, user interface module view, an item selection, or an item view.

17. The method of claim 14, wherein the user history representations represent patterns in the interaction data.

18. A non-transitory computer-readable storage medium storing executable instructions, which when executed by a processing device, cause the processing device to perform operations comprising:
receiving a plurality of user interface modules, wherein each one of the plurality of user interface modules includes one or more items, and interaction data corresponding to one or more interaction sessions;
generating, based on the interaction data and the plurality of user interface modules, one or more user history representations via a machine learning model;
based on the one or more user history representations, generating, a plurality of interaction likelihood predictions via the machine learning model, wherein each of the plurality of interaction likelihood predictions corresponds to a likelihood of interaction with at least one of the plurality of user interface modules;
based on one or more of the plurality of interaction likelihood predictions above a predefined threshold value, generating an arrangement of the one or more of the plurality of user interface modules for display via the user interface; and
broadcasting the arrangement of the one or more of the plurality of user interface modules for display.

19. The non-transitory computer-readable storage medium of claim 18, wherein the plurality of interaction likelihood predictions is generated by using a softmax layer.

20. The non-transitory computer-readable storage medium of claim 18, wherein the generating of the one or more user history representations further comprises:
generating component representations for each component of each of the one or more interaction events;
generating interaction event representations for each interaction event by combining the component representations corresponding to each respective interaction event; and
generating a user history representation for each interaction session by organizing the corresponding interaction event representations sequentially and aggregating the corresponding interaction event representations organized sequentially.
